(19) United States
(12) Patent Application Publication
(10) Pub. No.: US 2025/0083972 A1
(43) Pub. Date: Mar. 13, 2025

(54) TITANIUM DIOXIDE NANOMATERIAL, METHOD OF MANUFACTURING THE SAME AND SOLAR STEAM GENERATOR

(71) Applicant: NATIONAL SUN YAT-SEN UNIVERSITY, Kaohsiung (TW)

(72) Inventors: HUI-FEN WU, Kaohsiung City (TW); MAHESHIKA KUMARIHAMY, Kaohsiung City (TW)

(21) Appl. No.: 18/384,897

(22) Filed: Oct. 30, 2023

(30) Foreign Application Priority Data
Sep. 7, 2023 (TW) 112134092

(51) Int. Cl. C01G 23/053; C01G 23/08; F22B 1/00

(52) U.S. Cl. CPC C01G 23/0536; C01G 23/08; F22B 1/006; C01P 2004/64

(57) ABSTRACT

A method of manufacturing a titanium dioxide nanomaterial according to the present invention comprises: mixing a titanium (III) chloride solution, ethanol, and a sodium chloride solution to obtain a solution to be sonicated; performing probe ultrasonication to the solution to be sonicated with an opening time and a pulse closing time for a sonicating time at a power of 45 W to 55 W and under a temperature of 23° C. to 27° C. to obtain a reaction solution; adding deionized water dropwise into the reaction solution with a predetermined adding rate, and gradually increasing the temperature of the reaction solution to 80° C. with a predetermined ramping rate to obtain a solution to be centrifuged; and centrifuging the solution to be centrifuged to separate a precipitate, wherein the precipitate includes the titanium dioxide nanomaterial.

### CROSS REFERENCE TO RELATED APPLICATION

The application claims the benefit of Taiwan application serial No. 112134092, filed on Sep. 7, 2023, and the entire contents of which are incorporated herein by reference.

### BACKGROUND OF THE INVENTION

### 1. Field of the Invention

The present invention relates to a nanomaterial and, more particularly, to a titanium dioxide nanomaterial. The present application also relates to a method of manufacturing the titanium dioxide nanomaterial and a solar steam generator including the titanium dioxide nanomaterial.

### 2. Description of the Related Art

As the world's population increases rapidly, the demand for pure water resources is gradually increasing. However, to purify wastewater into drinking water is an expensive and time-consuming process. Conventional water purification methods must use a lot of chemicals, but these chemicals often cannot be recycled, thereby increasing costs and generate additional pollution.

In order to reduce the influence on the environment, environmentally friendly solar water purification has become an emerging water purification method. However, water purification methods that use solar energy to naturally evaporate water are limited by the extremely low evaporation rate in natural systems. Moreover, the solar steam generation devices disclosed so far usually have complex structure and bulky volume, which is inconvenient.

To improve the efficiency of water purification with solar energy, nanomaterial that can be used for solar photothermal exchange is applied to purify wastewater. Titanium dioxide (TiO₂) has the characteristics such as abundant raw materials reserves, low emissivity and broad light absorption spectrum, and thus is suitable as the photothermal exchange material. However, current titanium dioxide nanomaterials need to be doped with other materials or composited with other materials to form the photothermal exchange materials. Therefore, the method of manufacturing the photothermal exchange materials is complicated. Moreover, limited by the extremely low evaporation rate in natural systems, there is still room for improvement in the photothermal exchange efficiency of the formed photothermal exchange materials.

Thus, it is necessary to provide a titanium dioxide nanomaterial with good photothermal exchange efficiency, a method for manufacturing the same, and a simple and low-cost water purification device for solving the above issues.

### SUMMARY OF THE INVENTION

To solve the above problem, an objective of the present invention is to provide a method of manufacturing a titanium dioxide nanomaterial, which not only has mild and fast reaction conditions with simple steps, but also can manufacture a titanium dioxide nanomaterial with two-dimensional structures used to purify water by absorbing sunlight for photothermal reaction.

Another objective of the present invention is to provide a titanium dioxide nanomaterial manufactured by the above method with good phototheraml exchange efficiency.

Still another objective of the present invention is to provide a solar steam generator, which involves using the above titanium dioxide nanomaterial as the phototheraml exchange material for purifying water.

As used herein, directionality or similar terms, such as “front,” “back,” “left,” “right,” “upper (top),” “lower (bottom),” “inner,”, “outer,” “side,” etc. mainly refer to the directions of the attached drawings. Each directionality or its approximate terms are only used to assist in explaining and understanding the various embodiments of the present invention, and are not intended to limit the present invention.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “couple”, “combine”, “assemble”, or the like mainly include the forms that the components can be separated without damaging after being connected, or that the components are inseparable after being connected. These forms can be selected by one skilled in the art based on the materials of the components to be connected or the assembly requirements.

A method of manufacturing a titanium dioxide nanomaterial according to the present invention comprises: mixing a titanium (III) chloride solution, ethanol, and a sodium chloride solution to obtain a solution to be sonicated; performing probe ultrasonication to the solution to be sonicated with an opening time and a pulse closing time for a sonicating time at a power of 45 W to 55 W and under a temperature of 23° C. to 27° C. to obtain a reaction solution; adding deionized water dropwise into the reaction solution with a predetermined adding rate, and gradually increasing the temperature of the reaction solution to 80° C. with a predetermined ramping rate to obtain a solution to be centrifuged; and centrifuging the solution to be centrifuged to separate a precipitate, wherein the precipitate includes the titanium dioxide nanomaterial.

A titanium dioxide nanomaterial manufactured by the above method according to the present invention, wherein the titanium dioxide nanomaterial has a two-dimensional layered sheet structure and includes titanium (III) oxide.

A solar steam generator according to the present invention, comprising: a first container having an opening on a top end thereof; a second container having an opening on a top end thereof, wherein the first container is located within the second container; and a water purification component covering the opening of the second container, wherein the water purification component has a photothermal exchange part, a heat conduction part, and a water absorption part, the photothermal exchange part and the water absorption part are both adjacent to the heat conduction part, and a surface of the photothermal exchange part has the above titanium dioxide nanomaterial.

Thus, in the method of manufacturing a titanium dioxide nanomaterial according to the present invention, by using probe ultrasonication and coprecipitation, the manufactured titanium dioxide nanomaterial has a wide light absorption range, and thus can be used as a photothermal exchange material without further doping or modification steps. Moreover, the manufactured titanium dioxide nanomaterial has a two-dimensional structure, thereby increasing the active surface area, which can achieve the effect of improving photothermal exchange efficiency.

In an example, the opening time is 5 seconds, the pulse closing time is 1 second, and the sonicating time is 10 minutes, which may allow the titanium (III) chloride solution in the solution to be sonicated to dissociate in ethanol, providing the effect of quickly generating Ti³⁺ ions.

In an example, the predetermined adding rate is 1 ml deionized water per 5 minutes, and the predetermined ramping rate is 10° C. per 20 minutes, which may provide the effect of gently oxidizing Ti³⁺ ions to form Ti⁴⁺ ions with deionized water under slowly ramping conditions.

In an example, the method further inlcudes washing the precipitate with deionized water and ethanol and then drying the washed precipitate at 50° C. for 15 hours, which may remove the impurities and moisture of the precipitate to provide the effect of purifying the precipitate to obtain the titanium dioxide nanomaterial.

Moreover, the titanium dioxide nanomaterial of the present invention contains titanium (III) oxide having an absorption wavelength range of 300 to 400 nm, such that the titanium dioxide nanomaterial can absorb sunlight and convert it into heat energy in good photothermal conversion efficiency.

In an example, the absorption wavelength range of the titanium dioxide nanomaterial is between 300 to 400 nm. The absorption wavelength range of the titanium dioxide nanomaterial overlaps with the wavelength range of sunlight, which has the effect of improving the photothermal conversion efficiency of the titanium dioxide nanomaterial with respect to sunlight.

In addition, the solar steam generator of the present invention uses the titanium dioxide nanomaterial to absorb sunlight and convert it into heat energy, and evaporates and then condenses the sewage through the heat conduction of the heat conduction part and the capillary action of the water absorption part. Therefore, the sewage can be quickly and easily purified to meet the criteria for drinking water recommended by the World Health Organization (WHO), thereby reducing the impact on the environment during the water purification process.

In an example, the first container has a water inlet tube and a first water outlet tube, and one end of the water inlet tube and one end of the first water outlet tube are both connected to the inside of the first container. In this way, sewage can be easily injected into or discharged from the first container, which has the effect of improving convenience of use.

In an example, the second container has a sidewall, and the other end of the water inlet tube and the other end of the first water outlet tube each passes through at least one hole of the sidewall, which can isolate the sewage in the first container and the purified water in the second container, providing the effect of preventing the purified water from being contaminated.

In an example, the second container has a second water outlet tube connected to the inside of the second container. In this way, the purified water collected in the second container can be easily discharged and the vapor pressure at the bottom of the second container can be reduced, thereby providing the effect of maintaining the purified water condensation efficiency.

In an example, the cross-sectional area of the water purification component is equal to the cross-sectional area of the second container. In this way, the water purification component can firmly cover the opening of the second container, thereby providing the effect of improving the structural strength of the solar steam generator.

In an example, the photothermal exchange part is a natural fiber layer, and the titanium dioxide nanomaterial is coated on a surface of the natural fiber layer. Accordingly, the titanium dioxide nanomaterial can be evenly distributed on the top end of the solar steam generator, thereby providing the effect of reducing the aggregation of the nanomaterial and improving the photothermal exchange efficiency.

In an example, the heat conduction part is made of metal. Accordingly, the heat conduction part can have good thermal conductivity, thereby providing the effect of effectively transferring heat energy.

In an example, the water absorption part has at least one extension part extending into the inside of the first container. Accordingly, the water absorption part can absorb the sewage in the first container through the extension part, and evenly distribute the sewage under the heat conduction part, thereby providing the effect of improving the evaporation rate of the sewage.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 illustrates the UV-visible absorption spectrum of the titanium dioxide nanomaterial of the present invention.

FIG. 2 illustrates the X-ray diffraction spectrum of the titanium dioxide nanomaterial of the present invention.

FIG. 3 illustrates the 2p molecular orbital diagram of Titanium of the titanium dioxide nanomaterial of the present invention.

FIG. 4 illustrates the 1s molecular orbital diagram of Oxygen of the titanium dioxide nanomaterial of the present invention.

FIG. 5 illustrates the TEM image of the titanium dioxide nanomaterial of the present invention.

FIG. 6 illustrates a schematic view of a preferred embodiment of the solar steam generator of the present invention.

FIG. 7 illustrates the comparison of electrical conductivity of three water bodies before and after being purified by the solar steam generator.

FIG. 8 illustrates an enlarged view of the electrical conductivity of 0 to 2500 μS/cm in FIG. 7.

FIG. 9 illustrates the comparison of cation content of the seawater sample before and after being purified by the solar steam generator.

FIG. 10 illustrates an enlarged view of the concentration of 0 to 300 ppm in FIG. 9.

FIG. 11 illustrates the comparison of cation content of the lake water sample before and after being purified by the solar steam generator.

FIG. 12 illustrates the comparison of cation content of the river water sample before and after being purified by the solar steam generator.

FIG. 13 illustrates an enlarged view of the concentration of 0 to 400 ppm in FIG. 12.

### DETAILED DESCRIPTION OF THE INVENTION

In the following description, some preferred embodiments, taken in conjunction with the accompanying drawings, are set forth to provide a thorough understanding of the foregoing and other objects, features, and advantages of the present invention.

In an embodiment, a method of manufacturing the titanium dioxide nanomaterial of the present invention utilizes probe ultrasonication in combination with coprecipitation to obtain a two-dimensional titanium dioxide nanomaterial with good photothermal conversion efficiency.

Specifically, a titanium (III) chloride solution, ethanol, and a sodium chloride solution can be mixed to obtain a solution to be sonicated. In an embodiment, 1 ml of a titanium (III) chloride aqueous solution (10% to 15% by weight) and 8 ml of a sodium chloride aqueous solution (5 M) can be sequentially added into 12 ml of the ethanol to obtain the solution to be sonicated. Then, the solution to be sonicated is subjected to probe ultrasonication with a power of 45-55 W and a temperature of 23-27° C. to obtain a reaction solution. In an embodiment, the probe ultrasonication can be performed for 10 minutes with an opening time of 5 seconds and a pulse closing time of 1 second (5 sec ON/1 sec OFF pulse) as one cycle. The cycle can be repeated until the ultrasonication is finished with a total opening time of 500 seconds and a total pulse closing time of 100 seconds. In this way, Ti³⁺ ions can dissociate from the titanium (III) chloride in the solution to be sonicated.

Next, the Ti³⁺ ions in the reaction solution are oxidized to form Ti⁴⁺ ions, which can be precipitated into crystals using coprecipitation. Specifically, the reaction solution can be stirred at a rate of 350 rpm. While the stirring, the reaction temperature is increased from room temperature to 80° C. with a ramping rate of 10° C. per 20 minutes. During the heating process, 15 ml of deionized water is added dropwise at an adding rate of 1 ml per 5 minutes until a precipitate and thus a solution to be centrifuged are formed, wherein the deionized water can be deionized water with a resistivity of 18.2 MΩ·cm. The solution to be centrifuged is then centrifuged, preferably in a spin rate of 6000 rpm, to separate the precipitate, which includes a titanium dioxide nanomaterial. The precipitate can be washed with deionized water and ethanol, and then the washed precipitate can be dried in an oven at 50° C. for 15 hours to obtain the titanium dioxide nanomaterial.

The following experiments were performed to determine the properties of the titanium dioxide nanomaterial.

### Exp. A: Analysis Results of UV-Visible Spectrum

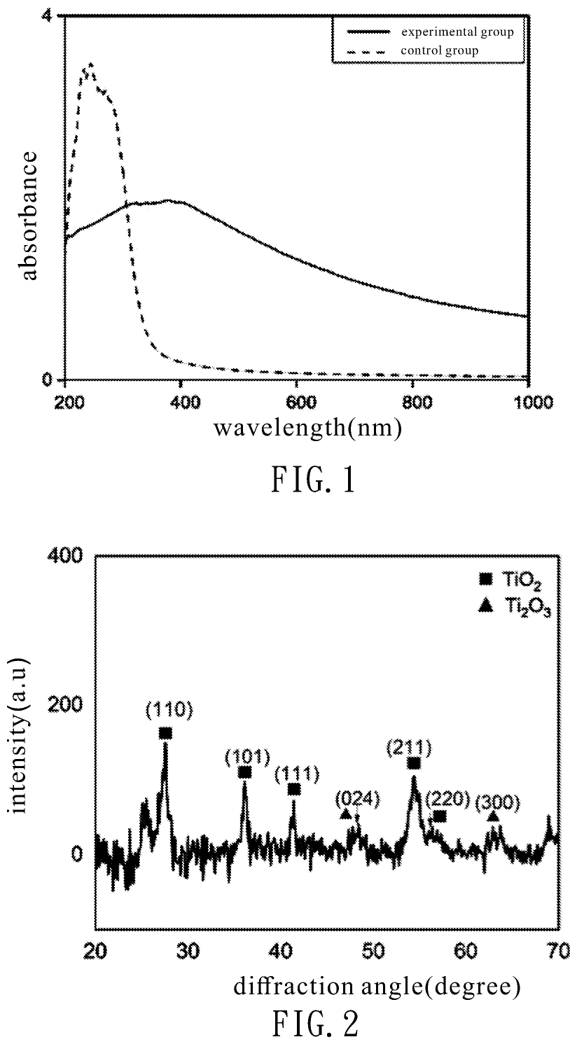

This experiment was performed to analyze the absorption intensity of the titanium dioxide nanomaterial in different wavelength regions using a UV-Visible spectrometer. The result is shown in FIG. 1. The titanium dioxide nanomaterial (the experimental group) has a broad characteristic peak at 300-400 nm, wherein the energy band near 300 nm shows that the nanomaterial contains titanium-oxygen bonds, while the peak at 350 nm shows that the titanium-oxygen bond in the nanomaterial comes from the titanium dioxide. In comparison, the characteristic peak of the sample without sodium chloride added during the manufacturing process (the control group) is located at 225-300 nm, indicating that the sample does not include the titanium dioxide nanomaterial.

### Exp. B: Analysis Results of X-Ray Diffraction

The titanium dioxide nanomaterial was analyzed using an X-ray diffractometer. The result is shown in FIG. 2. The peaks at 27.5°, 36.15°, 41.95°, 54.1°, and 55.8° respectively represent the lattice planes in (110), (101), (111), (211), and (220) directions of the rutile-phase of titanium dioxide. The two small peaks at 48.5° and 63.0° respectively represent the lattice planes in (024) and (300) directions of titanium (III) oxide, indicating that the titanium dioxide nanomaterial contains titanium (III) oxide.

### Exp. C: Elemental Analysis Results

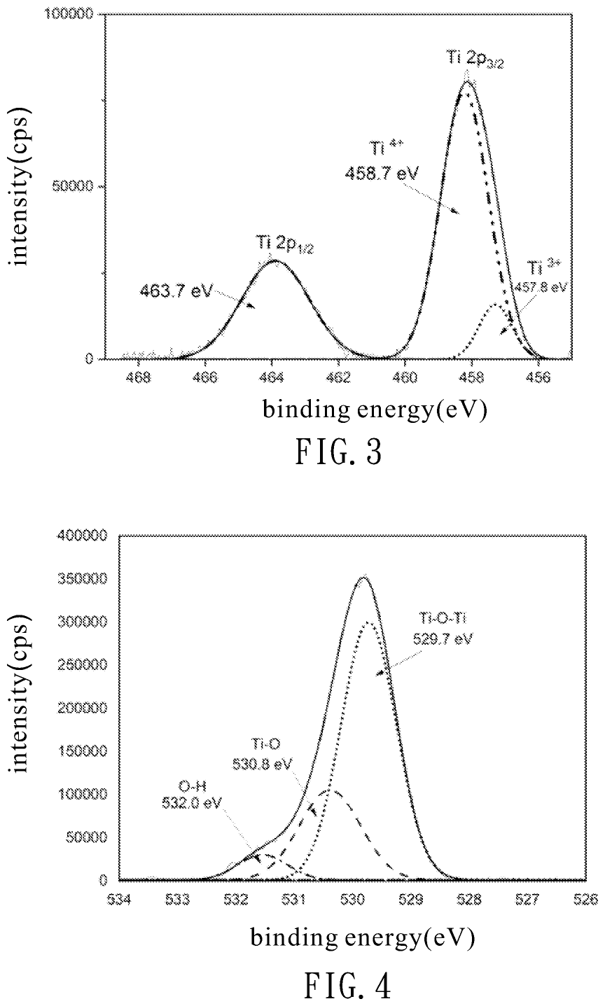

The titanium dioxide nanomaterial was analyzed using an X-ray photoelectron spectrometer to analyze the different states of titanium in the titanium dioxide nanomaterial. The result is shown in FIG. 3. The peaks at 458.7 and 463.7 eV represent Ti 2p_{3/2} and Ti 2p_{1/2} respectively, the peak near 458.7 eV corresponds to Ti⁴⁺ in titanium dioxide, and the peak at 457.8 eV corresponds to Ti³⁺ in titanium (III) oxide. Further, as shown in FIG. 4, the peaks with binding energies of 529.7, 530.8, and 532 eV respectively represent titanium-oxygen-titanium bonds, titanium-oxygen bonds and oxygen-hydrogen bonds. FIGS. 3 and 4 indicate that the titanium dioxide nanomaterial is indeed composed of titanium dioxide and titanium (III) oxide.

### Exp. D: Morphological Analysis Results

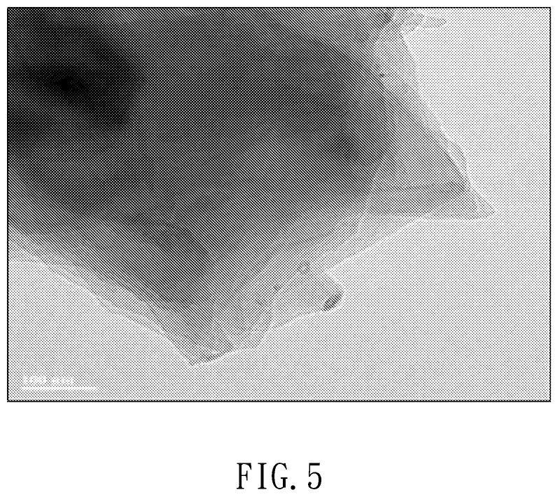

The titanium dioxide nanomaterial was analyzed using a transmission electron microscope to analyze the morphology of the titanium dioxide nanomaterial. The result is shown in FIG. 5, which shows that the titanium dioxide nanomaterial is a two-dimensional nanomaterial with a layered sheet structure. This indicates that the titanium dioxide nanomaterial has a larger active surface area, thereby enabling the titanium dioxide nanomaterial to have better photothermal exchange efficiency.

The titanium dioxide nanomaterial manufactured by the present method not only has the two-dimensional sheet structure and the light absorption range of 300-400 nm, but also has an inherent low emissivity of titanium dioxide and an abundance of raw material, etc. By the above characteristics, the titanium dioxide nanomaterial can have good photothermal exchange efficiency and can be used to convert solar energy into thermal energy.

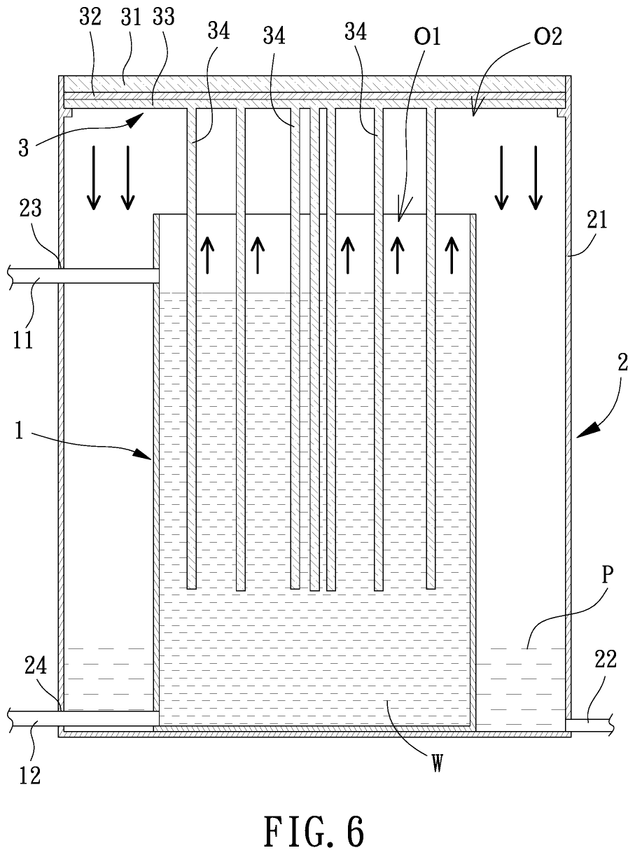

Now referring to FIG. 6, which shows a preferred embodiment of a solar steam generator of the present invention including a first container 1, a second container 2, and a water purification component 3. The first container 1 is located within the second container 2. There is a water storage space between the first container 1 and the second container 2. The water purification component 3 covers the top end of the second container 2.

The first container 1 and the second container 2 are both containers with an opening on the top end thereof (namely, an opening O1 of the first container 1 and an opening O2 of the second container 2). Moreover, the first container 1 and the second container 2 are preferably made of lightweight materials such as plastic or resin. In this embodiment, two cut PET bottles can be used as the first container 1 and the second container 2 to achieve the effect of recycling waste.

The first container 1 has a water inlet tube 11, one end of which is connected to the inside of the first container 1. The water inlet tube 11 is preferably located at the top or higher position of the first container 1, such that sewage W can be refilled into the first container 1 through the water inlet tube 11 when the level of sewage W in the first container 1 drops. The first container 1 also has a first water outlet tube 12, one end of which is connected to the inside of the first container 1. The first water outlet tube 12 is preferably located at the bottom or lower position of the first container 1, such that the sewage W with a high concentration after evaporation can be discharged from the first water outlet tube 12. This may avoid the concentration of contaminant in the sewage W from being too high to reduce the evaporation efficiency of sewage W.

The second container 2 includes a sidewall 21 and a second water outlet tube 22, wherein the sidewall 21 has at least one hole. In this embodiment, the sidewall has two holes 23 and 24, and the water inlet tube 11 and the first water outlet tube 12 can pass through the holes 23 and 24 respectively. The second water outlet tube 22 is communicated with the inside of the second container 2. The second water outlet tube 22 is preferably located at the bottom or lower position of the second container 2 for discharging the collected purified water P. When the amount of purified water P in the second container 2 is less than the amount of sewage W in the first container 1, the vapor pressure within the second container 2 will be less than the vapor pressure within the first container 1, which may cause continuous condensing of the purified water P in the second container 2 with a lower vapor pressure, thereby maintaining the condensation efficiency of the purified water P.

The water purification component 3 includes a photothermal exchange part 31, a heat conduction part 32, and a water absorption part 33. The photothermal exchange part 31 and the water absorption part 33 are both adjacent to the upper surface and the lower surface of the heat conduction part 32. The cross-sectional area of the water purification component 3 is preferably equal to that of the opening O2 of the second container 2.

The photothermal exchange part 31 can be used to absorb solar energy and convert the solar energy into thermal energy through a photothermal exchange process. The photothermal exchange part 31 can be a natural sponge cucumber fiber layer, and the titanium dioxide nanomaterial can be coated on the surface of the natural sponge cucumber fiber layer. The coating can be performed using various conventional surface treatment methods. Preferably, a spray bottle with a very small nozzle size can be used to evenly spray a predetermined amount of the dispersion of the titanium dioxide nanomaterial onto the natural sponge cucumber fiber layer. In this way, the natural sponge cucumber fiber layer can be evenly coated with the titanium dioxide nanomaterial, thereby avoiding aggregation of the titanium dioxide nanomaterial, and improving the evaporation efficiency of the sewage W.

The heat conduction part 32 is preferably made of metal. With the thermal conductivity of the heat conduction part 32, the heat energy generated by the photothermal exchange part 31 can be effectively conducted to the water absorption part 33, such that the sewage W absorbed by the water absorption part 33 can be evaporated. The heat conduction part 32 can also isolate the photothermal exchange part 31 from the evaporation cycle of the sewage W and the purified water P (described in detail below), thereby preventing contaminant or water vapor in the sewage W from contaminating the photothermal exchange part 31, and preventing the titanium dioxide nanomaterial in the photothermal exchange part 31 from dissolving into the purified water P.

The water absorption part 33 can be made of various materials with capillarity, for example. In this embodiment, the water absorption part 33 is made of cotton. The water absorption part 33 may further include at least one extension part 34 extending into the inside of the first container 1. Accordingly, the water absorption part 33 can continuously absorb the sewage W in the first container 1 through the capillary action of the at least one extension part 34, such that the sewage W can be evenly distributed on the lower surface of the heat conduction part 32 at a high temperature for evaporation. Compared to evaporating the sewage W in the first container 1 directly, absorbing the sewage W to the water absorption part 33 for evaporation can concentrate the heat energy generated by the photothermal exchange part 31 into the sewage W in the water absorption part 33, thereby preventing the heat energy generated by the photothermal exchange part 31 from being lost into a large amount of sewage W in the first container 1.

Specifically, when using the solar steam generator of the present invention, the sewage W is first injected into the first container 1 from the water inlet tube 11. After the solar steam generator is irradiated by sunlight, the photothermal exchange part 31 converts the sunlight into heat energy, and the heat energy is conducted to the water absorption part 33 through the heat conduction part 32. Meanwhile, because the water absorption part 33 is in contact with the heat conduction part 32, the sewage W is absorbed upward to the water absorption part 33 through the capillary action of the at least one extension part 34. Therefore, the sewage W can receive the heat energy generated by the photothermal exchange part 31 and thus evaporates. The water vapor generated after the evaporation of the sewage W condenses on the sidewall 21 of the second container 2 with a lower temperature to form purified water P, which can be discharged and collected through the second water outlet tube 22. Since the amount of purified water P in the second container 2 is less than the amount of sewage W in the first container 1, the vapor pressure of the second container 2 is less than that of the first container 1. Therefore, the purified water P condenses in the second container 2 with a lower vapor pressure and does not flow back into the first container 1 with a higher vapor pressure.

It is noted that the solar steam generator converts solar energy into thermal energy via the photothermal exchange part 31, the thermal energy can trigger the evaporation of the sewage W at a lower evaporation temperature of 33-35.5° C., such that the sewage W can undergo an evaporation cycle within this temperature range. Accordingly, the sewage W can be evaporated at a slower evaporation rate. In comparation with evaporating the sewage W by boiling, using the solar steam generator disclosed by the present invention can allow sufficient time for the water and contaminant in the sewage W to separate, thereby providing the effect of improving water purification.

To confirm the ability of the solar steam generator for improving the evaporation efficiency, deionized water was used as a water sample to measure the evaporation rate (Eᵣ) and percentage efficiency (n) of the solar steam generator under one sun illumination (i.e., 1.0 kW/m²). The evaporation rate is calculated according to the formula 1 below and the percentage efficiency is calculated according to the formula 2 below. After 12 to 18 hours of illumination, the evaporation rate and percentage efficiency of the solar steam generator can reach 1.17 kg/m² h and 79.9%, respectively, indicating that the solar steam generator has good evaporation cycle efficiency.

$${E}_{r} = ( {M}_{wl} - {M}_{dl} ) / ( t \times {A}_{w} ) \qquad ( formula 1 )$$

$$η ( \% ) = ( {M}_{w o} - {M}_{d o} ) \times ( {H}_{L V} + Q ) / ( {P}_{i n} \times t \times {A}_{w} ) \times 100 \qquad ( formula 2 )$$

In the above formula 1, M_{wl} and M_{dl} represent the mass of water evaporated by the solar steam generator with illumination and in the dark, respectively, t represents the illumination time, and A_{w} represents the open surface area of the water body (equivalent to the surface area of the heat conduction part 32). In the above formula 2, M_{wo} and M_{do} represent the mass of water lost by the solar steam generator with illumination and in the dark, respectively, H_{LV} represents the latent heat when water undergoes liquid-vapor phase change, Q is the sensible heat of the evaporation process, Pᵢₙ represents the incident solar flux power (solar flux power), t represents the illumination time, and A_{w} represents the open surface area of the water body (equivalent to the surface area of the fiber coated with the titanium dioxide nanomaterial).

In order to confirm the ability of the solar steam generator for purifying water quality, three different water bodies were used as sewage W to analyze the difference in water quality before and after being purified by the solar steam generator.

### Exp. E: Analysis Results of Water Quality Purification

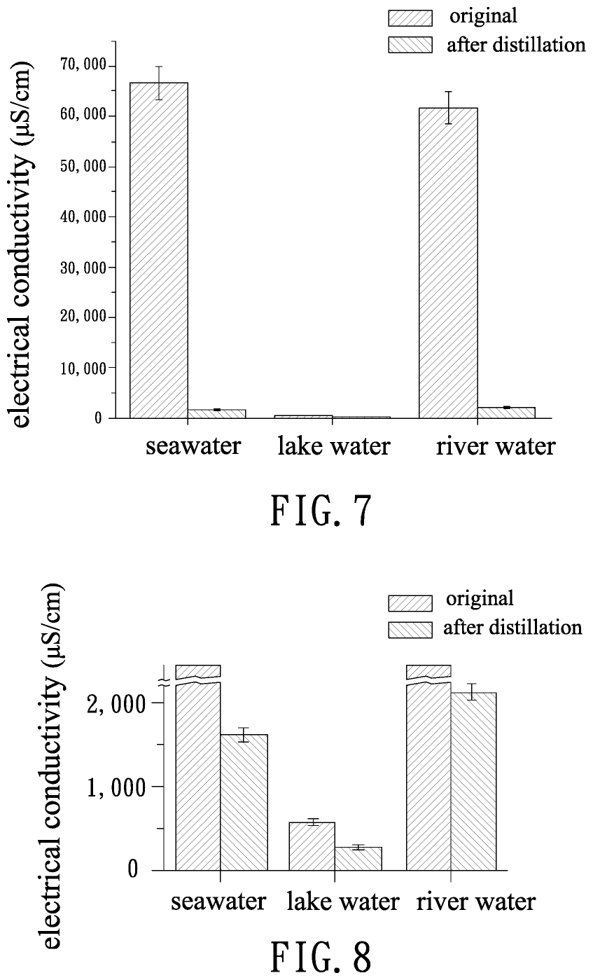

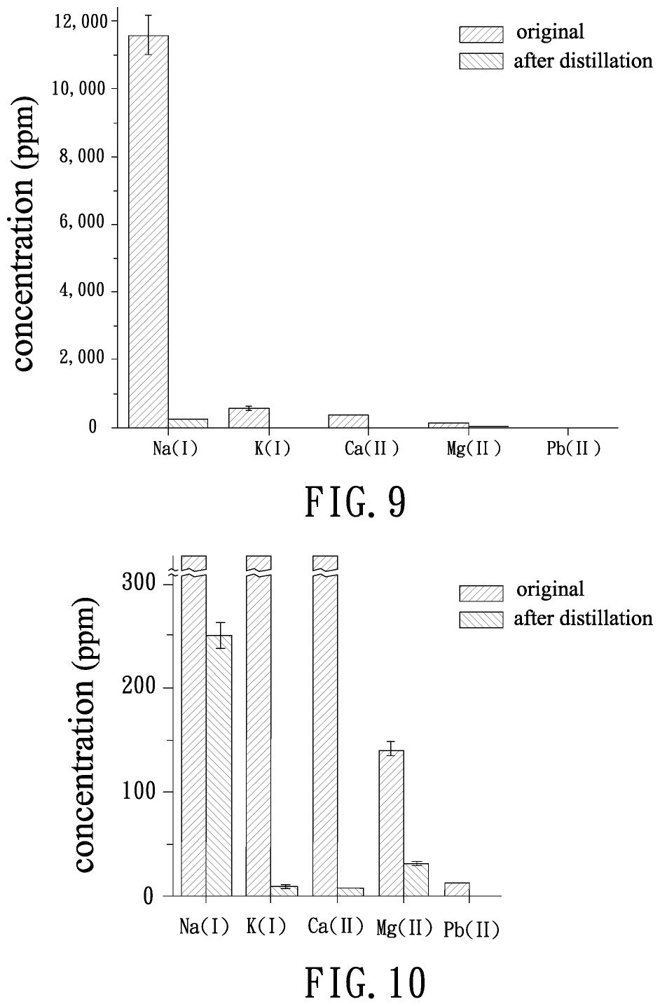

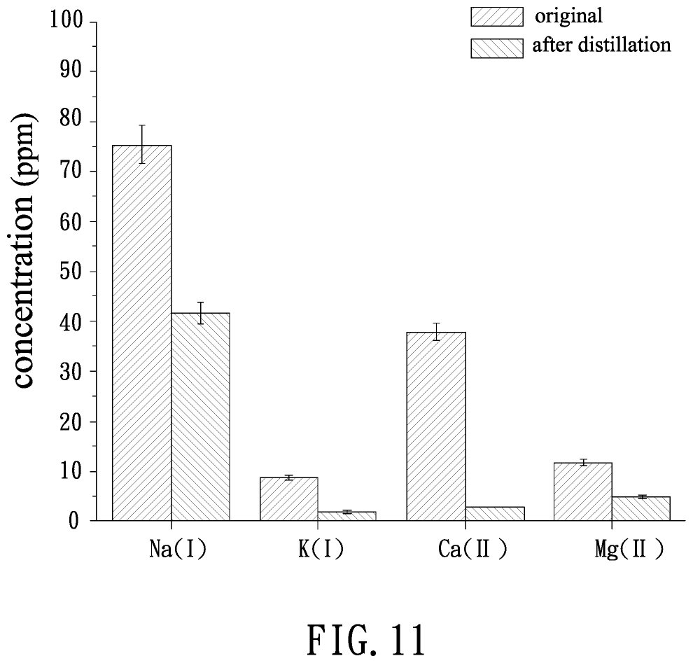

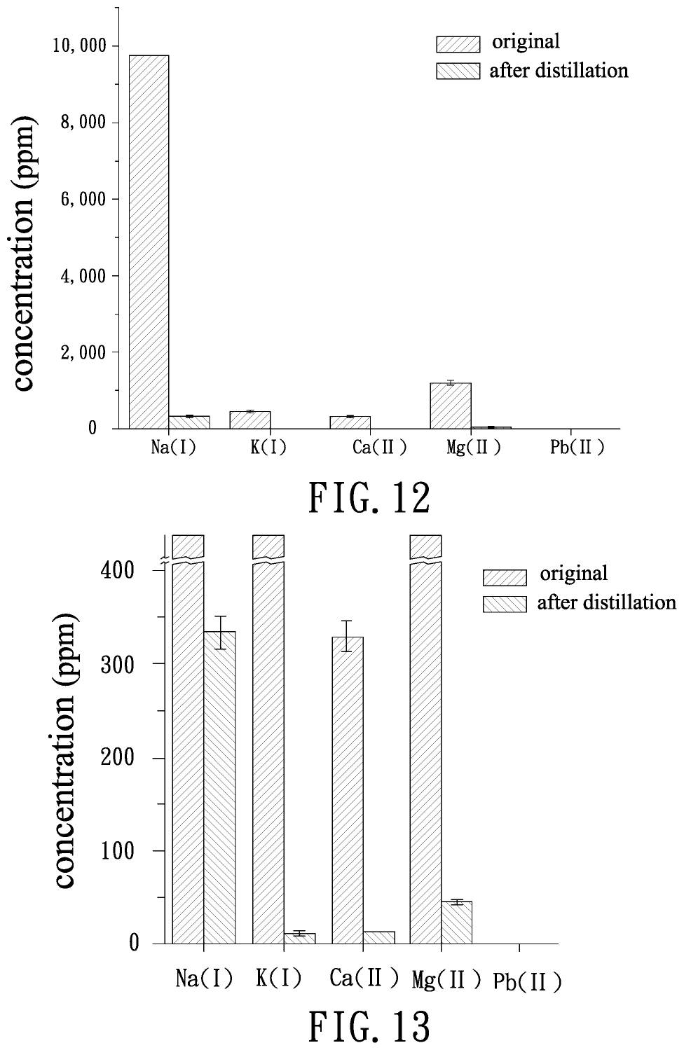

In this experiment, seawater from Chaishan Fishing Port, lake water from Jinshi Lake and river water from Aihe River were used as three different kinds of sewage W. The electrical conductivity (EC) of these water bodies before and after purification were analyzed using a conductivity meter, and the cation content and trace metal content of these water bodies before and after purification were analyzed using an inductively coupled plasma optical emission spectrometer (ICP-OES). The results are shown in FIGS. 7-15, which show that the conductivity and cation concentration of the three water bodies significantly decrease after being purified by the solar steam generator. In particular, the quality of the purified seawater and lake water can meet the criteria for drinking water recommended by the World Health Organization (WHO), showing that the solar steam generator does have a good water purification ability.

In summary, the method of manufacturing a titanium dioxide nanomaterial according to the present invention, by using probe ultrasonication and coprecipitation, the manufactured titanium dioxide nanomaterial has a wide light absorption range, and thus can be used as a photothermal exchange material without further doping or modification steps. Moreover, the manufactured titanium dioxide nanomaterial has a two-dimensional structure, thereby increasing the active surface area, which can achieve the effect of improving photothermal exchange efficiency.

In addition, the titanium dioxide nanomaterial of the present invention contains titanium (III) oxide having an absorption wavelength range of 300 to 400 nm, such that the titanium dioxide nanomaterial can absorb sunlight and convert it into heat energy in good photothermal conversion efficiency.

Furthermore, the solar steam generator of the present invention uses the titanium dioxide nanomaterial to absorb sunlight and convert it into heat energy, and evaporates and then condenses the sewage through the heat conduction of the heat conduction part and the capillary action of the water absorption part. Therefore, the sewage can be quickly and easily purified to meet the criteria for drinking water recommended by the World Health Organization (WHO), thereby reducing the impact on the environment during the water purification process.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A method of manufacturing a titanium dioxide nanomaterial, comprising:
mixing a titanium (III) chloride solution, ethanol, and a sodium chloride solution to obtain a solution to be sonicated;
performing probe ultrasonication to the solution to be sonicated with an opening time and a pulse closing time for a sonicating time at a power of 45 W to 55 W and under a temperature of 23° C. to 27° C. to obtain a reaction solution;
adding deionized water dropwise into the reaction solution with a predetermined adding rate, and gradually increasing the temperature of the reaction solution to 80° C. with a predetermined ramping rate to obtain a solution to be centrifuged; and
centrifuging the solution to be centrifuged to separate a precipitate, wherein the precipitate includes the titanium dioxide nanomaterial.

2. The method of claim 1, wherein the opening time is 5 seconds, the pulse closing time is 1 second, and the sonicating time is 10 minutes.

3. The method of claim 1, wherein the predetermined adding rate is 1 ml deionized water per 5 minutes, and the predetermined ramping rate is 10° C. per 20 minutes.

4. The method of claim 1, further comprising washing the precipitate with deionized water and ethanol and then drying the washed precipitate at 50° C. for 15 hours.

5. A titanium dioxide nanomaterial manufactured by the method of claim 1, wherein the titanium dioxide nanomaterial has a two-dimensional layered sheet structure and includes titanium (III) oxide.

6. The titanium dioxide nanomaterial of claim 5, wherein the absorption wavelength range of the titanium dioxide nanomaterial is between 300 to 400 nm.

7. A solar steam generator, comprising:
a first container having an opening on a top end thereof;
a second container having an opening on a top end thereof, wherein the first container is located within the second container; and
a water purification component covering the opening of the second container, wherein the water purification component has a photothermal exchange part, a heat conduction part, and a water absorption part, the photothermal exchange part and the water absorption part are both adjacent to the heat conduction part, and a surface of the photothermal exchange part has the titanium dioxide nanomaterial of claim 5.

8. The solar steam generator of claim 7, wherein the first container has a water inlet tube and a first water outlet tube, and one end of the water inlet tube and one end of the first water outlet tube are both connected to the inside of the first container.

9. The solar steam generator of claim 8, wherein the second container has a sidewall, and the other end of the water inlet tube and the other end of the first water outlet tube each passes through at least one hole of the sidewall.

10. The solar steam generator of claim 9, wherein the second container has a second water outlet tube connected to the inside of the second container.

11. The solar steam generator of claim 7, wherein the cross-sectional area of the water purification component is equal to the cross-sectional area of the second container.

12. The solar steam generator of claim 7, wherein the photothermal exchange part is a natural fiber layer, and the titanium dioxide nanomaterial is coated on a surface of the natural fiber layer.

13. The solar steam generator of claim 7, wherein the heat conduction part is made of metal.

14. The solar steam generator of claim 7, wherein the water absorption part has at least one extension part extending into the inside of the first container.
